(19) United States
(12) Patent Application Publication
(10) Pub. No.: US 2006/0046001 A1
(43) Pub. Date: Mar. 2, 2006

(54) Mordanted inkjet recording element and printing method

(76) Inventors: Charles E. Romano JR., Rochester, NY (US); Richard J. Kapusniak, Webster, NY (US); Lori J. Shaw-Klein, Rochester, NY (US); Terry C. Schultz, Hilton, NY (US); Peter J. Ghyzel, Rochester, NY (US)

Correspondence Address: Paul A. Leipold;Patent Legal Staff, Eastman Kodak Company, 343 State Street, Rochester, NY, 14650-2201, US

(21) Appl. No.: 10/925,506

(22) Filed: Aug. 25, 2004

(51) Int. Cl. B41M 5/00

(52) U.S. Cl. 428/32.34

(57) ABSTRACT

An inkjet recording element comprising a support having thereon, in order, a base layer comprising a hydrophilic polymer and a polymeric mordant, an inner layer, and an overcoat. Such recording elements exhibit improved resistance to humidity keeping.

### CROSS REFERENCE TO RELATED APPLICATIONS

Reference is made to commonly assigned, co-pending U.S. patent application Ser. No. ______ by Charles E. Romano, Jr. et al. (Docket 88020) filed of even date herewith and titled “INKJET RECORDING ELEMENT COMPRISING ALUMINOSILICATE AND ACETOACETYLATED POLY(VINYL ALCOHOL)” and U.S. patent application Ser. No. ______ by Charles E. Romano, Jr. (Docket 88595) filed of even date herewith and titled “INKJET RECORDING ELEMENT WITH IMPROVED INTERLAYER ADHESION AND A METHOD OF PRINTING.”

### FIELD OF THE INVENTION

The present invention relates to an inkjet recording element and a printing method using the element.

### BACKGROUND OF THE INVENTION

In a typical inkjet recording or printing system, ink droplets are ejected from a nozzle at high speed towards a recording element or medium to produce an image on the medium. The ink droplets, or recording liquid, generally comprise a recording agent, such as a dye or pigment, and a large amount of solvent. The solvent, or carrier liquid, typically is made up of water, an organic material such as a monohydric alcohol, a polyhydric alcohol, or mixtures thereof.

An inkjet recording element typically comprises a support having on at least one surface thereof one or more ink-receiving or image-forming layers, and includes those intended for reflection viewing, which have an opaque support, and those intended for viewing by transmitted light, which have a transparent support.

In order to achieve and maintain high quality images on such an inkjet recording element, the recording element must exhibit no banding, bleed, coalescence, or cracking in inked areas; exhibit the ability to absorb large amounts of ink (including carrier liquid) and dry quickly to avoid blocking; exhibit high optical densities in the printed areas; exhibit freedom from differential gloss; exhibit high levels of image fastness to avoid fade from contact with water or radiation by daylight, tungsten light, or fluorescent light or exposure to gaseous pollutants; and exhibit excellent adhesive strength so that delamination does not occur.

A typical inkjet recording element from the prior art comprises an overcoat layer containing hydroxypropylmethyl cellulose, hydroxyethyl cellulose and a vinyl latex polymer, a layer of pectin, a layer of poly(vinyl alcohol) and polyurethane, and a layer of lime processed osseine gelatin in the order recited.

U.S. patent Publication No. 2003/0112311 A1 published Jun. 19, 2003 by Naik et al., titled “Topcoat Compositions, Substrates Containing A Topcoat Derived Therefrom, and Methods of Preparing the Same” discloses an ink-receptive composition comprising a filler, binder such as polyvinyl alcohol and, as a mordant, a cationic polymer.

While a wide variety of different types of image recording elements for use with ink printing are known, there are many unsolved problems in the art and many deficiencies in the known products, which have severely limited their commercial usefulness. A major challenge in the design of an image-recording element is to provide improved picture life, a critical component of which is resistance to light fade.

It is an object of this invention to provide a multilayer ink recording element that has excellent image quality and improved picture life.

Still another object of the invention is to provide a printing method using the above-described element.

### SUMMARY OF THE INVENTION

These and other objects are achieved by the present invention which comprises a swellable (non-porous) inkjet recording element comprising a support having thereon, in order starting closest to the support, at least three layers, as follows:
(a) a base layer comprising a hydrophilic polymer, as a binder, and base-layer polymeric mordant (collectively one or more polymers) comprising between 1 and 10 percent solids of weakly mordanting cationic polymer comprising less than 50 mole percent of a cationic monomer, wherein substantially no other polymeric mordant is present in the base layer;
(b) an inner layer comprising polyvinyl alcohol or a derivative thereof and either (i) substantially no polymeric mordant in the inner layer or (ii) inner-layer polymeric mordant that is weakly mordanting cationic polymer having less than 50 mole percent of a cationic monomer, in which case (ii), there is substantially no other polymeric mordant other than the inner-layer polymeric mordant present in the inner layer; and
(c) a non-porous overcoat, preferably the topcoat, comprising polyvinyl alcohol;
   wherein the ratio of the thickness of the base layer (of the dried coating) to that of both the inner layer and overcoat is at least 2.5 to 1, preferably at least 3.5 to 1, more preferably between 4:1 and 10:1. In one preferred embodiment, the ratio is between 5:1 and 7:1. With respect to such ratios, each layer may or may not be divided and comprise one or more sub-layers.

As indicated by the fact that the base layer comprises a mordant for the ink (colorant) and is relatively thick compared to the other two layers, the base layer is intended to contain the principal amount of imaged ink after the ink is applied and dried. The phrase “substantially no polymeric mordant” herein is meant that the amount of mordant present in the layer is less than 20 weight percent, based on total mordant, preferably less than 15 weight percent, more preferably less than 10 weight percent, and most preferably zero or essentially no polymeric mordant in the layer.

Such recording elements, which comprise three or more non-porous (swellable) hydrophilic absorbing layers, exhibit improved light fade and excellent image quality.

A preferred embodiment of the present invention involves an inkjet recording element comprising in order, on a support, a gelatin-containing base layer, an inner layer as described above, and an overcoat comprising aluminosilicate particles. In one preferred embodiment, both the inner layer and the base layer comprise different cationic polymers, respectively a polyurethane and an acrylic latex. In another preferred embodiment, only the base layer comprises a polymeric mordant.

Another embodiment of the invention relates to an inkjet printing method comprising the steps of: A) providing an inkjet printer that is responsive to digital data signals; B) loading the inkjet printer with the inkjet recording element described above; C) loading the inkjet printer with an inkjet ink; and D) printing on the inkjet recording element using the inkjet ink in response to the digital data signals.

As used herein, the terms “over,” “above,” “under,” and the like, with respect to layers in the inkjet media, refer to the order of the layers over the support, but do not necessarily indicate that the layers are immediately adjacent or that there are no intermediate layers.

### DETAILED DESCRIPTION OF THE INVENTION

As noted above, the swellable inkjet recording element of the present invention comprises at least three non-porous hydrophilic absorbing layers each of which comprises independently a natural or synthetic polymer as binder.

The hydrophilic absorbing layers must effectively absorb both the water and humectants commonly found in printing inks as well as the recording agent (typically a dye-based colorant). The inner layer, the base layer, the overcoat layer, and any other hydrophilic ink-absorbing layers will collectively be referred to as hydrophilic absorbing layers. The ink colorant or image-forming portion of the ink may form a gradient within the recording element and may be present, to at least some degree in all three hydrophilic absorbing layers, typically forming a colorant gradient to some extent. However, due to the location of the mordant and the thickness of the layers, the base layer is intended to receive and contain most of the colorant, preferably more than 70% by weight of the applied colorant employing a typical inkjet dye-based composition.

In one embodiment of the invention, the hydrophilic absorbing layers comprise a first hydrophilic absorbing layer, a base layer comprising gelatin, and at least one upper layer or second hydrophilic absorbing layer (also referred to as the “inner layer”), located between the base layer and the overcoat layer, comprising poly(vinyl alcohol). These embodiments provide enhanced image quality.

Preferred binders for the hydrophilic absorbing layers comprise gelatin or poly (vinyl alcohol) (PVA). The layers, however, may also contain, for example, other hydrophilic materials such as naturally-occurring hydrophilic colloids and gums such as gelatin or modified gelatin, albumin, guar, xantham, acacia, chitosan, starches and their derivatives, functionalized proteins, functionalized gums and starches, and cellulose ethers and their derivatives, polyvinyloxazoline, such as poly(2-ethyl-2-oxazoline) (PEOX), polyvinylmethyloxazoline, polyvinylmethyloxazoline, polyoxides, polyethers, poly(ethylene imine), poly(acrylic acid), poly(methacrylic acid), n-vinyl amides including polyacrylamide and polyvinyl pyrrolidinone (PVP), and poly(vinyl alcohol) derivatives and copolymers, such as copolymers of poly(ethylene oxide) and poly(vinyl alcohol) (PEO-PVA), polyurethanes, and polymer latices such as polyesters and acrylates. Derivitized poly(vinyl alcohol) includes, but is not limited to, polymers having at least one hydroxyl group replaced by ether or ester groups, which may be used in the invention, for example an acetoacetylated poly(vinyl alcohol). A copolymer of poly(vinyl alcohol), for example, is carboxylated PVA in which the an acid group is present in a comonomer. More than one polymer may be present in a layer.

A preferred binder for the base layer is gelatin, which is preferably made from animal collagen, especially gelatin made from pig skin, cow skin, or cow bone collagen due to ready availability. This kind of gelatin is not specifically limited, but lime-processed gelatin, acid processed gelatin, amino group inactivated gelatin (such as acetylated gelatin, phthaloylated gelatin, malenoylated gelatin, benzoylated gelatin, succinylated gelatin, methyl urea gelatin, phenylcarbamoylated gelatin, and carboxy modified gelatin), or gelatin derivatives (for example, gelatin derivatives disclosed in JP Patent publications 38-4854/1962, 39-5514.1964, 40-12237/1965, 42-26345/1967, and 2-13595/1990; U.S. Pat. Nos. 2,525,753, 2,594,293, 2,614,928, 2,763,639, 3,118,766, 3,132,945, 3,186,846, 3,312,553; and GB Patents 861,414 and 103, 189) can be used singly or in combination. Most preferred are pigskin or modified pigskin gelatins and acid processed osseine gelatins due to their effectiveness for use in the present invention.

The poly(vinyl alcohol) employed in a preferred embodiment of the invention has a degree of hydrolysis of at least about 50% and has a number average molecular weight of at least about 45,000. In a particularly preferred embodiment of the invention, the poly(vinyl alcohol) has a degree of hydrolysis of about 70 to 99%, more preferably about 75 to 90%. Commercial embodiments of such poly(vinyl alcohol) include Gohsenol® AH-22, Gohsenol® AH-26, Gohsenol® KH-20, and Gohsenol® GH-17 from Nippon Gohsei and Elvanol®52-22 from DuPont (Wilmington, Del.).

In one embodiment of the invention, the inner layer comprises a derivitized or copolymerized poly(vinyl alcohol) selected from the group acetoacetylated and carboxylated poly(vinyl alcohol). The derivitized poly(vinyl alcohol) has at least one hydroxyl group replaced by ester groups, preferably an acetoacetylated poly(vinyl alcohol) in which the hydroxyl groups are esterified with acetoacetic acid. Preferably the derivitized poly(vinyl alcohol) has an average molecular weight of from 15,000 to 150,000, a saponification degree (mol %) of from 80-100%, and a modification degree (mol %) of from 2.5-15%. These derivitized poly(vinyl alcohol) compounds are readily available from various commercial suppliers.

In another embodiment, the inner layer comprises a poly(vinyl alcohol) binder and particles of a synthetic, substantially amorphous aluminosilicate material. In one such embodiment, the degree of hydrolysis of the poly(vinyl alcohol) in the overcoat is not more than 80%, the degree of hydrolysis of the poly(vinyl alcohol) in the inner layer at least 80%, and the degree of hydrolysis of the poly(vinyl alcohol) in the inner layer is at least 5% greater than that of the overcoat.

In still another embodiment of the invention, the inner layer comprises a mixture of poly(vinyl alcohol) and a cationic polyurethane latex dispersion, such as Witcobond® 213, in a ratio of 50:50 to 95:5 PVA to polyurethane. Chelating agents such as EDTA (ethylene diamine tetraacetic acid), in an amount of 0.01 to 2.0 weight percent, preferably about 0.4 weight percent, can be included in the composition for the inner layer (and also in the overcoat when PVA is used as the binder) to prevent crosslinking with metal contaminants or other undesirable reactions.

The dry-layer thickness of the inner layer is preferably from 0.5 to 10 μm (more preferably 1 to 5 microns). The preferred dry coverage of the overcoat layer is from 0.5 to 5 μm (more preferably 0.5 to 1.5 microns) as is common in practice. The dry-layer thickness of the base layer is preferably from 5 to 60 microns (more preferably 6 to 15 microns), below which the layer is too thin to be effective and above which no additional gain in performance is noted with increased thickness.

Referring again to the hydrophilic absorbing layers, dye mordants are added to at least the base layer, optionally also in the inner layer, in order to improve smear resistance at high relative humidity. The term “cationic polymeric mordant” is intended to include polymers comprising the reaction product of a cationic monomer (mordant moiety) which monomer comprises free amines, protonated free amines, and quaternary ammonium, as well as other cationic groups such as phosphonium. A weakly polymeric mordant is used in the hydrophilic absorbing layer or layers of the invention. In general, strong mordants although allowing relatively less dye mobility can adversely effect light fade resistance. The present configuration of the inkjet recording element in which a relatively weak mordant is placed in an underlying layer has been found to provide improved light fade resistance and excellent image quality at the same time.

Preferably, the mordants used in the present invention are cationic polymers, e.g., a polymeric quaternary ammonium compound, such as poly(dimethylaminoethyl)-methacrylate, polyalkylenepolyamines, and products of the condensation thereof with dicyanodiamide, amine-epichlorohydrin polycondensates, lecithin and phospholipid compounds. Examples of mordants useful in the invention include vinylbenzyl trimethyl ammonium chloride/ethylene glycol dimethacrylate, vinylbenzyl trimethyl ammonium chloride/divinyl benzene, poly(diallyl dimethyl ammonium chloride), poly(2-N,N,N-trimethylammonium)ethyl methacrylate methosulfate, poly(3-N,N,N-trimethyl-ammonium)propyl methacrylate chloride, a copolymer of vinylpyrrolidinone and vinyl(N-methylimidazolium chloride, and hydroxyethyl cellulose derivitized with (3-N,N,N-trimethylammonium)propyl chloride.

Some specific examples of water insoluble, cationic polymeric particles which may be used in the invention include those described in U.S. Pat. No. 3,958,995, hereby incorporated by reference in its entirety. Specific examples of these polymers include, for example, a terpolymer of styrene, (vinylbenzyl)dimethylbenzylamine and divinylbenzene (49.5:49.5:1.0 molar ratio); and a terpolymer of butyl acrylate, 2-aminoethylmethacrylate hydrochloride and hydroxyethylmethacrylate (50:20:30 molar ratio).

The cationic polymer can be water-soluble or can be in the form of a latex, water dispersible polymer, beads, or core/shell particles wherein the core is organic or inorganic and the shell in either case is a cationic polymer. Such particles can be products of addition or condensation polymerization, or a combination of both. They can be linear, branched, hyper-branched, grafted, random, blocked, or can have other polymer microstructures well known to those in the art. They also can be partially crosslinked. Examples of core/shell particles useful in the invention are disclosed in U.S. Pat. No. 6,619,797 issued Sep. 16, 2003 to Lawrence et al., titled “Inkjet Printing Method.” Examples of water-dispersible particles useful in the invention are disclosed in U.S. Pat. No. 6,454,404 issued Sep. 24, 2002 to Lawrence et al., titled “Inkjet Printing Method,” and U.S. Pat. No. 6,503,608 issued Jan. 7, 2003 to Lawrence et al., titled “Inkjet Printing Method.”

Preferably, cationic polymeric particles comprising at least 10 mole percent of a cationic mordant moiety (monomeric unit) are employed in the base layer.

Such cationic polymeric particles useful in the invention can be derived from nonionic or cationic monomers. In a preferred embodiment, combinations of nonionic and cationic monomers are employed. The nonionic or cationic monomers employed can include neutral or cationic derivatives of addition polymerizable monomers such as styrenes, alpha-alkylstyrenes, acrylate esters derived from alcohols or phenols, methacrylate esters (usually referred to as methacrylate), vinylimidazoles, vinylpyridines, vinylpyrrolidinones, acrylamides, methacrylamides, vinyl esters derived from straight chain and branched acids (e.g., vinyl acetate), vinyl ethers (e.g., vinyl methyl ether), vinyl nitriles, vinyl ketones, halogen-containing monomers such as vinyl chloride, and olefins, such as butadiene.

The nonionic or cationic monomers employed can also include neutral or cationic derivatives of condensation polymerizable monomers such as those used to prepare polyesters, polyethers, polycarbonates, polyureas and polyurethanes.

Water insoluble, cationic polymeric particles that can be employed in this invention can be prepared using conventional polymerization techniques including, but not limited to bulk, solution, emulsion, or suspension polymerization. They are also commercially available usually from a variety of sources.

The amount of cationic polymer used, especially in the base layer, should be high enough so that the images printed on the recording element will have a sufficiently high density. In a preferred embodiment of the invention, the cationic polymeric particles are used in the amount of about 5 to 30 weight percent solids, preferably 10 to 20 weight percent in the base layer, based on total weight of the dried coating. If present in the inner layer, the inner layer may optionally contain an amount of mordant polymer, preferably in the form of articles, in the same range.

As mentioned above, the base layer preferably comprises a base-layer polymeric mordant comprising between 1 and 10 percent solids of weakly mordanting cationic polymer comprising less than 50 mole percent of a cationic monomer, wherein substantially no other polymeric mordant is present in the base layer. Preferably, the base layer comprises between 2 and 8 percent by weight solids of the base-layer polymeric mordant.

In one embodiment, the base-layer polymeric mordant is a non-particulate cationic polymer as a result of being coated in soluble form, and comprises between 10 to 30 mole percent of a cationic monomer that comprises free amines substantially protonated with an acid. Such a polymeric mordant may be a cationic polymer that is insoluble when in the unprotonated form. In a particularly preferred embodiment, the base-layer polymeric mordant is a cationic acrylic polymer.

The optional inner-layer polymeric mordant, as mentioned above, is also a weakly mordanting cationic polymer having less than 50 mole percent of a cationic monomer. In one embodiment, the inner-layer mordant is present and in the form of particles. The inner layer, in such a case, preferably comprises between 15 and 25 of the inner-layer polymeric mordant, which inner-layer polymeric mordant has between 10 and 30 mole percent of a cationic monomer. In a particularly preferred embodiment, the inner-layer polymeric mordant is cationic polymeric latex comprising cationic monomer containing a quaternized ammonium group, for example, cationic polyurethane latex.

In one particular embodiment, the cationic polymeric mordant for the inner layer is cationic polyurethane, preferably a water-dispersible polyurethane polymer, having the following general formula: 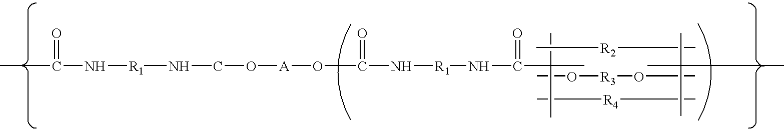
wherein:

R₁ is represented by one or more of the following structures:

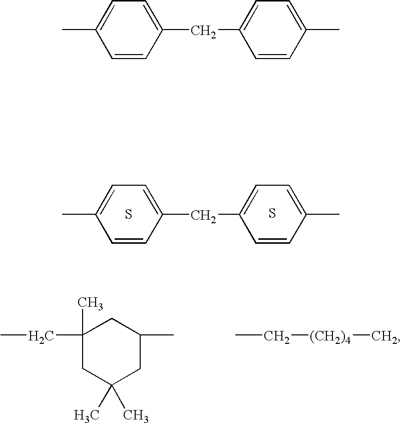

A represents the residue of a polyol, such as a) a dihydroxy polyester obtained by esterification of a dicarboxylic acid such as succinic acid, adipic acid, suberic acid, azelaic acid, sebacic acid, phthalic, isophthalic, terephthalic, tetrahydrophthalic acid, and the like, and a diol such as ethylene glycol, propylene-1,2-glycol, propylene-1,3-glycol, diethylene glycol, butane-1,4-diol, hexane-1,6-diol, octane-1,8-diol, neopentyl glycol, 2-methyl-propane-1,3-diol, nonane-1,9-diol or the various isomeric bis-hydroxymethylcyclohexanes, b) a polylactone such as polymers of F-caprolactone and one of the above mentioned diols, c) a polycarbonate obtained, for example, by reacting one of the above-mentioned diols with diaryl carbonates or phosgene, or d) a polyether such as a polymer or copolymer of styrene oxide, propylene oxide,-tetrahydrofuran, butylene oxide or epichlorohydrin. Preferably, A represents the residue of a dihydroxy polyester as in a).

R₂ represents the residue of a diol having a molecular weight less than about 500, such as the diols listed above for A, and

R₃ represents a monomeric unit comprising a cationic moiety, typically a quaternized ammonium salt, for example, wherein —OR₃O— is a residue of N,N-bis(hydroxyethyl)N,N-dimethyl quaternary ammonium methane sulfonate and higher ethoxylated derivatives formed by the reaction of tertiary amine with ethylene oxide, as disclosed, for example, in EP 0718276 B1 and EP 0718 276 B1.

R₄ is the residue of a diamine having a molecular weight less than about 500, such as ethylene diamine, diethylene triamine, propylene diamine, butylene diamine, hexamethylene diamine, cyclohexylene diamine, phenylene diamine, tolylene diamine, xylylene diamine, 3,3′-dinitrobenzidene, 4,4′-methylenebis(2-chloroaniline), 3,3′-dichloro-4,4′-biphenyl diamine, 2,6-diaminopyridine, 4,4′-diamino diphenylmethane, and adducts of diethylene triamine with acrylate or its hydrolyzed products. These materials are preferred due to their availability and compatibility with the present invention.

A preferred polyurethane mordant which may be employed in the invention preferably has a Tg between about −50° C. and 100° C. A plasticizer may also be added if desired. In a preferred embodiment of the invention, the polyurethane has a number average molecular weight of from about 5,000 to about 100,000, more preferably from 10,000 to 50,000. A water-dispersible polyurethane that can be employed in the invention may be prepared as described in “Polyurethane Handbook,” Hanser Publishers, Munich Vienna, 1985. Polyurethanes with these properties are readily available and effective in the present invention. A particular example of a water-dispersible polyurethane that may be used in the inner layer of the invention is Witcobond® 213 (Witco Corporation).

In one embodiment, a preferred cationic polymer for the base layer is a cationic acrylic polymer. Glascol®R-350 (Ciba), for example, is an acrylic latex that is preferably used in its solubilized form by lowering the pH sufficiently. A preferred cationic acrylic polymer comprises alkyl methacrylate such as methyl or ethyl (meth)acrylate and dialkylaminoalkyl (meth)acrylates such as 2-trimethylammonium ethyl acrylate and/or methacrylate. Cationic acrylic polymers are also disclosed in EP 0216 479 B2 to Farrar (Allied Colloids Limited).

As mentioned above, in another preferred embodiment of the invention, the inner layer comprises polyvinyl alcohol or a derivative thereof and there is substantially no polymeric mordant present in the inner layer, for example, wherein the uppermost layer comprising the mordant being the base layer. The binder for the overcoat can optionally include, in addition to the polyvinyl alcohol, any of the polymers mentioned above for the hydrophilic absorbing layers and/or may also contain other hydrophilic materials such as cellulose derivatives, e.g., cellulose ethers like methyl cellulose (MC), ethyl cellulose, hydroxypropyl cellulose (HPC), sodium carboxymethyl cellulose (CMC), calcium carboxymethyl cellulose, methylethyl cellulose, methylhydroxyethyl cellulose, hydroxypropylmethyl cellulose (HPMC), hydroxybutylmethyl cellulose, ethylhydroxyethyl cellulose, sodium carboxymethyl-hydroxyethyl cellulose, and carboxymethylethyl cellulose, and cellulose ether esters such as hydroxypropylmethyl cellulose phthalate, hydroxypropylmethyl cellulose acetate succinate, hydroxypropyl cellulose acetate, esters of hydroxyethyl cellulose and diallyldimethyl ammonium chloride, esters of hydroxyethyl cellulose and 2-hydroxypropyltrimethylammonium chloride and esters of hydroxyethyl cellulose and a lauryldimethylammonium substituted epoxide (HEC-LDME), such as Quatrisoft® LM200 (Amerchol Corp.) as well as hydroxyethyl cellulose grafted with alkyl C₁₂-C₁₄ chains.

The overcoat is non-porous. Optionally, particles or beads, inorganic or organic, can be present in the overcoat in an amount up to about 40 weight percent total solids. Such particles can be used for various purposes, to increase solids, to provide a matte finish, as filler, as a viscosity reducer, and/or to increase smudge resistance. The use of aluminosilicate particles in an overcoat to increase smudge resistance is disclosed in U.S. Ser. No. 10/705,057 by Charles E. Romano, Jr. et al., titled “Ink Jet Recording element and Printing Element” filed Nov. 10, 2003, hereby incorporated by reference in its entirety.

The inner layer and/or the overcoat can optionally comprise from about 2.5 to 30 percent by weight solids of particles of a synthetic aluminosilicate material, preferably about 5 to 20 wt % of the layer solids. The use of aluminosilicate particles in an inner layer to improve adhesion is disclosed in U.S. Ser. No. 10/759,896 by Richard Kapusniak, et al., titled “Ink Jet Recording Element Comprising Subbing Layer and Printing Method” filed Nov. 10, 2003, hereby incorporated by reference in its entirety.

The preferred aluminosilicate is similar to natural allophane, but is a synthetically produced material not derived from a natural or purified natural aluminosilicate material and that is substantially amorphous. In one embodiment the particles are in the form of spheres or rings, preferably substantially spherical spheres 1 to 10 nm in average diameter, as observable under an electron microscope. The aluminosilicate that may be used in the present invention, accordingly, includes materials termed “synthetic allophane” or “allophane like.” Synthetic allophane is typically in the form of substantially spherically or ring shaped aluminosilicate, including hollow spherical aluminosilicate particles, preferably having an average diameter of between 3.5 and 5.5 nm. Synthetic allophane differs from natural allophane (such as Allophosite® sold by Sigma) in that it does not contain iron. It may also be more amorphous and acidic. Synthetic allophanes, like natural allophanes, which are substantially amorphous (P. Bayliss, Can. Mineral. Mag., 1987, 327), can be compared to, for example, imogolites which are crystalline and fibril shaped.

The primary particles of the above-described aluminosilicate can be in the form of clusters of primary particles. It is a polymeric aluminosilicate material having the formula:
AlₓSi_{y}Oₐ(OH)_{b}.nH₂O
where the ratio of x:y is between 0.5 and 4, a and b are selected such that the rule of charge neutrality is obeyed; and n is between 0 and 10.

Naturally occurring allophane is a series name used to describe clay-sized, short-range ordered aluminosilicates associated with the weathering of volcanic ashes and glasses. Synthetic allophane, like natural allophane, is a substantially amorphous material having weak XRD signals. The particle size (average diameter) typically is in the range of about 4 to 5.5 nm. Due to their small size, it is difficult to obtain a photo of a single unit of synthetic allophane, but they commonly appear substantially spherical, which spheres are usually hollow. The zeta potential of synthetic allophane is positive, which is in the range of other pure alumina materials. There is data supporting the chemical anisotropy of synthetic allophane, with aluminols at the outer surface, silanols wrapping the inner surface.

Aluminosilicate polymers, in spherical particle form, that can be described as synthetic allophanes are disclosed in U.S. Pat. No. 6,254,845 issued Jul. 3, 2001 to Ohashi et al., titled “Synthesis Method Of Spherical Hollow Aluminosilicate Cluster,” which patent describes an improved method for preparing hollow spheres of amorphous aluminosilicate polymer similar to natural allophane. This patent also refers to Wada, S., Nendo Kagaku (Journal of the Clay Science Soc. of Japan), Vol. 25, No. 2, pp. 53-60, 1985) for another synthesis of amorphous aluminosilicate superfine particles. The aluminosilicate polymers in U.S. Pat. No. 6,254,845 to Ohashi et al. are within a range of 1-10 nm, shaped as hollow spheres, and are observed to form hollow spherical silicate “clusters” or aggregates in which pores are formed. The patent to Ohashi et al. states that powder X-ray diffraction reveals two broad peaks close to 27° and 40° at 2θ on the Cu—K_{α} line, which correspond to a non-crystalline (substantially amorphous) structure and which is characteristic of spherical particles referred to as allophane. In addition, observations under a transmission microscope reveal a state in which hollow spherical particles with diameters of 3-5 nm are evenly distributed.

Regarding the Al/Si ratio, it is believed that sufficient silanol group is needed to form an homogeneous layer of silicate on the face of the proto gibbsite sheet, sufficient to curl this protogibbsite sheet and finally allowing a closo structure to be obtained. The Al/Si ratio, therefore, has to be in the range 1 to 4.

Two types of synthetic allophane, referred to as hybrid and classical, are disclosed in French Applications FR 0209086 and FR 0209085 filed on Jul. 18, 2002, hereby incorporated by reference in their entirety. Hybrid synthetic allophanes show the same fingerprints as classical allophane with some additional bands due to the presence of organic groups.

As indicated above, synthetic and natural allophane is generally non-crystalline materials, which include both amorphous and short-range ordered materials such as microcrystalline materials. Amorphous materials are at the opposite extreme from crystalline materials—they do not have a regularly repeating structure, even on a molecular scale. Their compositions may be regular or, as is more commonly the case, they may have a large degree of variability. They do not produce XRD peaks. Since the term amorphous is sometime applied to materials that are truly amorphous, like volcanic glass, the term x-ray amorphous or simply non-crystalline can be used to describe allophanes and other short-range ordered materials that may show weak XRD peaks and hence not completely amorphous. Such aluminosilicate materials will be referred to herein as substantially amorphous. Short-range ordered materials can sometimes be identified by XRD or selective dissolution in conjunction with differential XRD.

In a particularly preferred embodiment, a polymeric aluminosilicate used in the overcoat of the inkjet recording element has the formula:
AlₓSi_{y}Oₐ(OH)_{b}.nH2O
where the ratio of x:y is between 1 and 3.6, preferably 1 to 3, more preferably 1 to 2, and a and b are selected such that the rule of charge neutrality is obeyed; and n is between 0 and 10. More preferably, it is a substantially amorphous aluminosilicate, spherical or ring shaped, with a general molar ratio of Al to Si not more than 2:1.

A polymeric aluminosilicate can be obtained, for example, by the controlled hydrolysis by an aqueous alkali solution of a mixture of an aluminum compound such as halide, perchloric, nitrate, sulfate salts or alkoxides species Al(OR)₃, and a silicon compound such as alkoxides species, wherein the molar ratio Al/Si is maintained between 1 and 3.6 and the alkali/Al molar ratio is maintained between 2.3 and 3. Such materials are described in French patent application FR 02/9085, hereby incorporated by reference in its entirety.

The polymeric aluminosilicate can be obtained by the controlled hydrolysis by an aqueous alkali solution of a mixture of an aluminum compound such as halide, perchloric, nitrate, sulfate salts or alkoxides species Al(OR)₃ and a silicon compound made of mixture of tetraalkoxide Si(OR)₄ and organotrialkoxide R′Si(OR)₃, wherein the molar ratio is maintained between 1 and 3.6 and the alkali/Al molar ratio is maintained 2.3 and 3. Such materials are described in the above-mentioned French patent application FR 02/9086.

Synthetic hollow aluminosilicates are disclosed in U.S. Pat. No. 6,254,845 issued Jul. 3, 2001 to Ohashi et al., titled “Synthesis Method Of Spherical Hollow Aluminosilicate Cluster,” hereby incorporated by reference. As mentioned earlier, the method used therein results in a synthetic allophane in which powder X-ray diffraction reveals two broad peaks close to 27° and 40° at 2θ on the Cu—K_{α} line, which correspond to a non-crystalline (substantially amorphous) structure and which is characteristic of spherical particles referred to as allophane. In some cases, allophanes have also been characterized as giving weak XRD peaks at least at about 2.2 and 3.3. The method of synthesis may affect the XRD pattern, however, and depending on the preparation, additional peaks may be present at about 7.7 to 8.4 Å and/or about 1.40 Å.

In more detail, a preferred method for preparing an aluminosilicate polymer comprises the following steps:

(a) treating a mixed aluminum and silicon alkoxide only comprising hydrolyzable functions, or a mixed aluminum and silicon precursor resulting from the hydrolysis of a mixture of aluminum compounds and silicon compounds only comprising hydrolyzable functions, with an aqueous alkali, in the presence of silanol groups, the aluminum concentration being maintained at less than 1.0 mol/l, the Al/Si molar ratio being maintained between 1 and 3.6 and the alkali/Al molar ratio being maintained between 2.3 and 3;

(b) stirring the mixture resulting from step (a) at ambient temperature in the presence of silanol groups long enough to form the aluminosilicate polymer; and

(c) eliminating the byproducts formed during steps (a) and (b) from the reaction medium.

The expression “hydrolyzable function” means a substituent eliminated by hydrolysis during the process and in particular at the time of treatment with the aqueous alkali. The expression “unmodified mixed aluminum and silicon alkoxide” or “unmodified mixed aluminum and silicon precursor” means respectively a mixed aluminum and silicon alkoxide only having hydrolyzable functions, or a mixed aluminum and silicon precursor resulting from the hydrolysis of a mixture of aluminum compounds and silicon compounds only having hydrolyzable functions. More generally, an “unmodified” compound is a compound that only comprises hydrolyzable substituents.

Step (c) can be carried out according to different well-known methods, such as washing or diafiltration.

The aluminosilicate polymer material obtainable by the method defined above has a substantially amorphous structure shown by electron diffraction. This material is characterized in that its Raman spectrum comprises in spectral region 200-600 cm⁻¹ a wide band at 250±6 cm⁻¹, a wide intense band at 359±6 cm⁻¹, a shoulder at 407±7 cm⁻¹, and a wide band at 501±6 cm⁻¹, the Raman spectrum being produced for the material resulting from step (b) and before step (c).

Alternatively, hybrid aluminosilicate polymers involving the introduction of functions, in particular organic functions into the inorganic aluminosilicate polymer enables a hybrid aluminosilicate polymer to be obtained in comparison to inorganic aluminosilicate polymers. A method for preparing a hybrid aluminosilicate polymer, comprises the following steps:

(a) treating a mixed aluminum and silicon alkoxide of which the silicon has both hydrolyzable substituents and a non-hydrolyzable substituent, or a mixed aluminum and silicon precursor resulting from the hydrolysis of a mixture of aluminum compounds and silicon compounds only having hydrolyzable substituents and silicon compounds having a non-hydrolyzable substituent, with an aqueous alkali, in the presence of silanol groups, the aluminum concentration being maintained at less than 0.3 moll, the Al/Si molar ratio being maintained between 1 and 3.6 and the alkali/Al molar ratio being maintained between 2.3 and 3;

(b) stirring the mixture resulting from step (a) at ambient temperature in the presence of silanol groups long enough to form the hybrid aluminosilicate polymer; and

(c) eliminating the byproducts formed during steps (a) and (b) from the reaction medium.

The expression “non-hydrolyzable substituent” means a substituent that does not separate from the silicon atom during the process and in particular at the time of treatment with the aqueous alkali. Such substituents are for example hydrogen, fluoride or an organic group. On the contrary the expression “hydrolyzable substituent” means a substituent eliminated by hydrolysis in the same conditions. The expression “modified mixed aluminum and silicon alkoxide” means a mixed aluminum and silicon alkoxide in which the aluminum atom only has hydrolyzable substituents and the silicon atom has both hydrolyzable substituents and a non-hydrolyzable substituent. Similarly, the expression “modified mixed aluminum and silicon precursor” means a precursor obtained by hydrolysis of a mixture of aluminum compounds and silicon compounds only having hydrolyzable substituents and silicon compounds having a non-hydrolyzable substituent. This is the non-hydrolyzable substituent that will be found again in the hybrid aluminosilicate polymer material of the present invention. More generally, an “unmodified” compound is a compound that only consists of hydrolyzable substituents and a “modified” compound is a compound that consists of a non-hydrolyzable substituent. This material is characterized by a Raman spectrum similar to the material obtained in the previous synthesis, as well as bands corresponding to the silicon-non-hydrolyzable substituent (bands linked to the non-hydrolyzable substituent can be juxtaposed with other bands), the Raman spectrum being produced for the material resulting from step (b) and before step (c).

The support for the inkjet recording element used in the invention can be any of those usually used for inkjet receivers, such as resin-coated paper, paper, polyesters, or microporous materials such as polyethylene polymer-containing material sold by PPG Industries, Inc., Pittsburgh, Pa. under the trade name of Teslin®, Tyvek® synthetic paper (DuPont Corp.), and OPPalyte® films (Mobil Chemical Co.) and other composite films listed in U.S. Pat. No. 5,244,861. Opaque supports include plain paper, coated paper, synthetic paper, photographic paper support, melt-extrusion-coated paper, and laminated paper, such as biaxially oriented support laminates. Biaxially oriented support laminates are described in U.S. Pat. Nos. 5,853,965; 5,866,282; 5,874,205; 5,888,643; 5,888,681; 5,888,683; and 5,888,714. These biaxially oriented supports include a paper base and a biaxially oriented polyolefin sheet, typically polypropylene, laminated to one or both sides of the paper base. Transparent supports include glass, cellulose derivatives, e.g., a cellulose ester, cellulose triacetate, cellulose diacetate, cellulose acetate propionate, cellulose acetate butyrate; polyesters, such as poly(ethylene terephthalate), poly(ethylene naphthalate), poly(1,4-cyclohexanedimethylene terephthalate), poly(butylene terephthalate), and copolymers thereof; polyimides; polyamides; polycarbonates; polystyrene; polyolefins, such as polyethylene or polypropylene; polysulfones; polyacrylates; polyetherimides; and mixtures thereof. The papers listed above include a broad range of papers, from high end papers, such as photographic paper to low end papers, such as newsprint. In a preferred embodiment, polyethylene-coated or poly(ethylene terephthalate) paper is employed.

The support used in the invention may have a thickness of from 50 to 500 μm, preferably from 75 to 300 μm. Antioxidants, antistatic agents, plasticizers and other known additives may be incorporated into the support, if desired.

In order to improve the adhesion of the base layer or, in the absence of a base layer, the inner layer, to the support, the surface of the support may be subjected to a corona-discharge treatment prior to applying a subsequent layer. The adhesion of the ink recording layer to the support may also be improved by coating a subbing layer on the support. Examples of materials useful in a subbing layer include halogenated phenols and partially hydrolyzed vinyl chloride-co-vinyl acetate polymer Coating compositions employed in the invention may be applied by any number of well known techniques, including dip-coating, wound-wire rod coating, doctor blade coating, gravure and reverse-roll coating, slide coating, bead coating, extrusion coating, curtain coating and the like. Known coating and drying methods are described in further detail in Research Disclosure no. 308119, published December 1989, pages 1007 to 1008. Slide coating is preferred, in which the base layers and overcoat may be simultaneously applied. After coating, the layers are generally dried by simple evaporation, which may be accelerated by known techniques such as convection heating.

To improve colorant fade, UV absorbers, radical quenchers or antioxidants may also be added to the image-receiving layer as is well known in the art. Other additives include pH modifiers, adhesion promoters, rheology modifiers, surfactants, biocides, lubricants, dyes, optical brighteners, matte agents, antistatic agents, etc. In order to obtain adequate coatability, additives known to those familiar with such art such as surfactants, defoamers, alcohol and the like may be used. A common level for coating aids is 0.01 to 0.30% active coating aid based on the total solution weight. These coating aids can be nonionic, anionic, cationic or amphoteric. Specific examples are described in MCCUTCHEON's Volume 1: Emulsifiers and Detergents, 1995, North American Edition.

Matte particles may be added to any or all of the layers described in order to provide enhanced printer transport, resistance to ink offset, or to change the appearance of the ink receiving layer to satin or matte finish. In addition, surfactants, defoamers, or other coatability-enhancing materials may be added as required by the coating technique chosen.

In another embodiment of the invention, a filled layer containing light-scattering particles such as titania may be situated between a clear support material and the hydrophilic absorbing layers described herein. Such a combination may be effectively used as a backlit material for signage applications. Yet another embodiment which yields an ink receiver with appropriate properties for backlit display applications results from selection of a partially voided or filled poly(ethylene terephthalate) film as a support material, in which the voids or fillers in the support material supply sufficient light scattering to diff-use light sources situated behind the image.

Optionally, an additional backing layer or coating may be applied to the backside of a support (i.e., the side of the support opposite the side on which the image-recording layers are coated) for the purposes of improving the machine-handling properties and curl of the recording element, controlling the friction and resistivity thereof, and the like.

Typically, the backing layer may comprise a binder and a filler. Typical fillers include amorphous and crystalline silicas, poly(methyl methacrylate), hollow sphere polystyrene beads, micro-crystalline cellulose, zinc oxide, talc, and the like. The filler loaded in the backing layer is generally less than 5 percent by weight of the binder component and the average particle size of the filler material is in the range of 5 to 30 μm. Typical binders used in the backing layer are polymers such as polyacrylates, gelatin, polymethacrylates, polystyrenes, polyacrylamides, vinyl chloride-vinyl acetate copolymers, poly(vinyl alcohol), cellulose derivatives, and the like. Additionally, an antistatic agent also can be included in the backing layer to prevent static hindrance of the recording element. Particularly suitable antistatic agents are compounds such as dodecylbenzenesulfonate sodium salt, octylsulfonate potassium salt, oligostyrenesulfonate sodium salt, laurylsulfosuccinate sodium salt, and the like. The antistatic agent may be added to the binder composition in an amount of 0.1 to 15 percent by weight, based on the weight of the binder. An image-recording layer may also be coated on the backside, if desired.

While not necessary, the hydrophilic layers described above may also include a cross-linker. Such an additive can improve the adhesion of a layer to the substrate as well as contribute to the cohesive strength and water resistance of the layer. Cross-linkers such as carbodiimides, polyfunctional aziridines, melamine formaldehydes, isocyanates, epoxides, and the like may be used. If a cross-linker is added, care must be taken that excessive amounts are not used as this will decrease the swellability of the layer, reducing the drying rate of the printed areas.

The coating composition can be coated either from water or organic solvents. However, water is preferred. The total solids content should be selected to yield a useful coating thickness in the most economical way, and for particulate coating formulations, solids contents from 10-40% are typical.

Inkjet inks used to image the recording elements of the present invention are well known in the art. The ink compositions used in inkjet printing typically are liquid compositions comprising a solvent or carrier liquid, dyes or pigments, humectants, organic solvents, detergents, thickeners, preservatives, and the like. The solvent or carrier liquid can be solely water or can be water mixed with other water-miscible solvents such as polyhydric alcohols. Inks in which organic materials such as polyhydric alcohols are the predominant carrier or solvent liquid may also be used. Particularly useful are mixed solvents of water and polyhydric alcohols. The dyes used in such compositions are typically water-soluble direct or acid type dyes. Such liquid compositions have been described extensively in the prior art including, for example, U.S. Pat. Nos. 4,381,946; 4,239,543; and 4,781,758.

The following example is provided to illustrate the invention.

### EXAMPLE 1

Solution for Overcoats—A liquid solution was made by dissolving a partially hydrolyzed polyvinyl alcohol (KH-20® from Nippon Gohsei) in water and adding two coating surfactants (Olin 10 G® from Olin Corp. and Zonyl FS300® from Dupont Corp.) with the ratios of dry chemicals being 100 parts KH170® to 3 parts Olin 10 G and 3 part Zonyl FSN®. The solution is made at 5.9% solids in water.

Inner layer solution for Control Coating 1—A liquid solution was made by dissolving a partially hydrolyzed polyvinyl alcohol (Elvanol 52-22® DuPont. The solution is made at 6% solids in water.

Inner layer solution for Control Coating 2 and Invention Coating 2—A liquid solution was made by dissolving a partially hydrolyzed polyvinyl alcohol (Elvanol 52-22® DuPont) and adding a cationic acrylic dispersion (Glascol R-350® from Ciba) with the weight ratios of the dry chemicals being 77 parts Elvanol 52-22® to 23 parts Glascol R-350® acrylic. The solution is made at 7.7% solids in water.

Inner layer solution for Control Coating 3 and Invention Coating 3—A liquid solution was made by dissolving a partially hydrolyzed polyvinyl alcohol (Elvanol 52-22® DuPont) and adding a cationic polyurethane dispersion (Superflex 600® from Dai-ichi Kogyo Seiyaku Company, LtdD.) with the weight ratios of the dry chemicals being 77 parts Elvanol 52-22® to 23 parts Superflex® acrylic. The solution is made at 7.8% solids in water.

Inner layer solution for Control Coating 4 and Invention Example 4—A liquid solution was made by dissolving a partially hydrolyzed polyvinyl alcohol (Elvanol 52-22® DuPont) and adding a cationic polyurethane dispersion (Witcobond 213® from Crompton Corp.) with the weight ratios of the dry chemicals being 77 parts Elvanol 52-22® to 23 parts Superflex 600® acrylic. The solution is made at 8. 1% solids in water.

Inner layer solution for Control 5—Same as for control coating 4

Base layer solution for Control Coating 1, 2, 3, and 4—A liquid solution was made by dissolving a pigskin gelatin (commercially available from Nitta Gelatine Company) and 0.5 parts 12 μm beads. The solution is made at 14% solids in water.

Base layer solution for Invention Coatings 1, 2, 3, 4—A liquid solution was made by dissolving a pigskin gelatin (commercially available from Nitta Gelatine Company) and adding a cationic mordant (Glascol R-350® commercially available from Ciba) that has been pH adjusted to 4.7 with acetic acid and adding 12 μm polystyrene polymer beads with the ratios of dry chemicals being 90 parts pigskin gelatin to 10 parts Glascol R-350® polymer to 0.5 parts 12 μm beads. The solution is made at 14% solids in water.

Base layer solution for Control Coating 5—A liquid solution was made by dissolving a pigskin gelatin (commercially available from Nitta Gelatine Company) and adding a strong cationic polymeric mordant, which is a copolymer of (vinylbenzyl)trimethylammonium chloride and divinyl benzene prepared from 87% by weight of N-vinylbenzyl-N,N,N-trimethylammonium chloride and 13% by weight of divinylbenzene) and adding 12 μm polystyrene polymer beads with the ratios of dry chemicals being 90 parts pigskin gelatin to 10 parts strong mordant to 0.5 parts 12 μm beads. The solution is made at 14% solids in water.

Recording Elements—Recording elements are created by simultaneously coating the layers on a corona discharge treated polyethylene resin coated paper using a slide hopper and dried thoroughly by forced air heat after application of the coating solutions. Solution for Base Layer 1 is coated directly on the paper with the coating of the solution for the Inner Layer 1 on top of Base Layer 1 and the solution for Overcoat 1 coated on top of Inner Layer 1 to yield dry thicknesses of 10 μm for the Base Layer 1 layer, 1.0 μm for the Inner Layer 1 and 1.0 μm for the Overcoat Layer 1.

Testing:

A test pattern was created in Corel Draw® software. Four 0.25 inch square patches were created specifying 25%, 50%, 75% and 100% coverage for each of the following colors: cyan, magenta, yellow, and black. The above coatings were printed with a Canon i950® desktop inkjet printer and measured for Status A reflection density. The prints were then exposed for 14 days to 80K-lux polycarbonate-filtered fluorescent lighting. The prints were again measured for Status A reflection density. % Density loss after exposure was calculated for each color from an initial 1.0 density above Dmin. The data reported in Table 1 is the largest density loss from the four color patches. A density loss of 30% results in failure.

A photographic image of four children sitting on a couch with a gray background behind them was captured as a jpeg file and imported into Corel® Draw. The photograph was printed on the coatings using an Canon® i950 inkjet printer using the glossy photo paper media type and high quality setting. The prints were then incubated at 38° C. /80% RH for 7 days and rated for print sharpness. A rating of good or excellent is acceptable.

TABLE 1

| | | | Inner Layer | Base Layer | Lighfade - | HHK |
|---|---|---|---|---|---|---|
| Element | Inner Layer (100 mg/ft2) | Base Layer (1000 mg/ft2) | Mordant | Mordant | % Density Loss | Sharpness |
| Control 1 | Elvanol* 52-22 PVA | Gel 55¹ | none | none | 20 | poor |
| Control 2 | Elvanol 52-22 PVA/Glascol** R350 | Gel 55 | weak | none | 25 | poor |
| Control 3 | Elvanol 52-22 PVA/Superflex² (77/23) | Gel 55 | weak | none | 23 | poor |
| Control 4 | Elvanol 52-22 PVA/Witcobond 213*** | Gel 55 | weak | none | 25 | poor |
| | (77/23) | | | | | |
| Invention 1 | Elvanol 52-22 PVA | Gel 55/Glascol R350 (90/10) | none | Weak | 25 | good |
| Invention 2 | Elvanol 52-22 PVA/Glascol R350 | Gel 55/Glascol R350 (90/10) | weak | Weak | 24 | good |
| | (77/23) | | | | | |
| invention 3 | Elvanol 52-22 PVA /Superflex (77/23) | Gel 55/Glascol R350 (90/10) | weak | Weak | 24 | good |
| Invention 4 | Elvanol 52-22 PVA/Witcobond 213 | Gel 55/Glascol R350 (90/10) | weak | Weak | 28 | good |
| | (77/23) | | | | | |
| Control 5 | Elvanol 52-22 PVA/Witcobond 213 | Gel 55 and Strong Mordant | weak | strong | 30 | excellent |
| | (77/23) | (90/10) | | | | |

*registered trademark of Dupont.
**registered trademark of Ciba.
***registered trademark of Crompton Corp.
¹registered trademark of Nitta Gelatine Company.
²registered trademark of Dai-ichi Kogyo Seiyaku Company, Lyf.

As shown by the results in Table 1 above, the coating with a strong mordant in the base layer exhibited poor light fade. It failed the 14-day light-fade test. In contrast, the coatings with no mordant or weak mordant in the inner layer and weak mordant in the base layer showed good light fade.

The results show that the control elements are unacceptable for high humidity keeping or light fade, whereas the invention elements are more than acceptable.

1. A swellable non-porous inkjet recording element comprising a support having thereon, in order, at least three non-porous layers, as follows:
(a) a base layer comprising a hydrophilic polymer, as a binder, and base-layer polymeric mordant comprising between 1 and 10 percent solids of weakly mordanting cationic polymer comprising less than 50 mole percent of a cationic monomer, wherein substantially no other polymeric mordant is present in the base layer;
(b) an inner layer comprising polyvinyl alcohol or a derivative thereof and either (i) substantially no polymeric mordant in the inner layer or (ii) inner-layer polymeric mordant that is weakly mordanting cationic polymer having less than 50 mole percent of a cationic monomer and substantially no other polymeric mordant other than the inner-layer polymeric mordant present in the inner layer; and
(c) a non-porous overcoat comprising a hydrophilic polymer which overcoat comprises substantially no polymeric mordant; and
wherein the ratio of the thickness of the base layer to that of the inner layer and overcoat is at least 2.5 to 1.

2. The inkjet recording element of claim 1 wherein the base layer comprises between 2 and 8 percent by weight solids of the base-layer polymeric mordant.

3. The inkjet recording element of claim 1 wherein the base-layer polymeric mordant is a non-particulate cationic polymer as a result of being coated in soluble form.

4. The inkjet recording element of claim 1 wherein the base-layer polymeric mordant comprises between 10 and 30 mole percent of a cationic monomer.

5. The inkjet recording element of claim 1 wherein the base-layer polymeric mordant comprises free amines substantially protonated with an acid.

6. The inkjet recording element of claim 1 wherein the hydrophilic polymer in the base layer is gelatin or polyvinyl alcohol.

7. The inkjet recording element of claim 1 wherein the base-layer polymeric mordant is a cationic polymer that which is insoluble when in the unprotonated form.

8. The inkjet recording element of claim 7 wherein the base-layer polymeric mordant is a cationic acrylic polymer.

9. The inkjet recording element of claim 1 wherein the inner-layer polymeric mordant is present and in the form of particles.

10. The inkjet recording element of claim 9 wherein the inner-layer, based on total weight of components, comprises between 15 and 25 weight percent of the inner-layer polymeric mordant.

11. The inkjet recording element of claim 9 wherein the inner-layer polymeric mordant has between 10 and 30 mole percent of a cationic monomer.

12. The inkjet recording element of claim 9 wherein the inner-layer polymeric mordant is cationic polymeric latex comprising cationic monomer containing a quaternized ammonium group.

13. The inkjet recording element of claim 12 wherein the inner-layer polymeric mordant is cationic polyurethane latex.

14. The inkjet recording element of claim 1 wherein the dry layer thickness of the inner layer is from 0.5 to 10 μm, the dry coverage of the overcoat layer is from 0.5 to 5 μm, and the dry layer thickness of the base layer is from 5 to 60 μm.

15. The inkjet recording element of claim 1 wherein dry layer thickness of the inner layer is from 1 to 5 μm, the dry coverage of the overcoat layer is from 0.5 to 1.5 μm, and the dry layer thickness of the base layer is from 6 to 15 μm.

16. The inkjet recording element of claim 15 wherein the overcoat and/or the inner layer comprises 1 to 30 weight percent of inorganic particles that are a synthetic, substantially amorphous aluminosilicate material, primary particles thereof having an average diameter of 1 to 10 nm, wherein the synthetic, substantially amorphous aluminosilicate material exhibits an X-ray diffraction pattern that comprises weak peaks at about 2.2 and 3.3 Å.

17. The inkjet recording element of claim 16 wherein the synthetic, substantially amorphous aluminosilicate material is substantially in the form of hollow spheres.

18. The inkjet recording element of claim 15 wherein the synthetic, substantially amorphous particles are present in an amount of 5 to 15 weight percent solids and wherein the ratio of hydrophilic binder to the synthetic, substantially amorphous aluminosilicate material is about from about 95:5 to about 85:15.

19. A swellable non-porous inkjet recording element comprising a support having thereon, in order, at least three layers, as follows:
(a) a base layer comprising a hydrophilic polymer, as a binder, and base-layer polymeric mordant comprising between 1 and 10 percent solids of weakly mordanting cationic polymer comprising less than 50 mole percent of a cationic monomer, wherein substantially no other polymeric mordant is present in the base layer;
(b) an inner layer comprising polyvinyl alcohol or a derivative thereof and there is substantially no polymeric mordant in the inner layer; and
(c) a non-porous overcoat comprising polyvinyl alcohol; wherein the ratio of the thickness of the base layer to that of the inner layer and overcoat is at least 2.5 to 1

20. An ink jet printing method, comprising the steps of:
A) providing an ink jet printer that is responsive to digital data signals;
B) loading the printer with the ink jet recording element of claim 1;
C) loading the printer with an ink jet ink; and
D) printing on the ink jet recording element using the ink jet ink in response to the digital data signals.

21. The inkjet printing method of claim 19 wherein a printed inkjet recording element is characterized by a differential gloss of at least about 20.
